(19) United States
(12) Patent Application Publication
(10) Pub. No.: US 2021/0032907 A1
(43) Pub. Date: Feb. 4, 2021

(54) COMPUTER SECURITY LOCK

(71) Applicant: TARGUS INTERNATIONAL LLC, Anaheim, CA (US)

(72) Inventors: Jonny Yuan, Placentia, CA (US); Rodger Dale Thomason, Santa Monica, CA (US)

(21) Appl. No.: 16/938,161

(22) Filed: Jul. 24, 2020

Related U.S. Application Data
(60) Provisional application No. 62/880,423, filed on Jul. 30, 2019.

(51) Int. Cl. E05B 73/00; E05B 37/02

(52) U.S. Cl. CPC E05B 73/0082; E05B 73/0005; E05B 37/025

(57) ABSTRACT

A lock for securing a computer with a computer slot, is disclosed. The lock includes a locking head with a fixed locking arm, a rotatable locking arm, a control link operably connected to the rotatable locking arm and configured to translate along a longitudinal axis of the locking head, and a biasing element that provides a resistive force or torque against the rotatable locking arm when the lock is in a locked configuration.

### RELATED APPLICATIONS

This application claims priority to U.S. Patent Application No. 62/880,423 filed on Jul. 30, 2019 and is incorporated herein by reference in its entirety.

### TECHNICAL FIELD

This disclosure generally relates to the field of security locks for electronic devices. More specifically, this disclosure relates to the field of computer security locks with locking arms.

### BRIEF DESCRIPTION OF THE DRAWINGS

Non-limiting and non-exhaustive embodiments of the disclosure are described, including various embodiments of the disclosure with reference to the figures, in which:

FIG. 1A illustrates an exploded view of a computer security lock, according to a first embodiment.

FIG. 1B illustrates a side view of the computer security lock of FIG. 1A in an unlocked position.

FIG. 1C illustrates a section view of the computer security lock of FIG. 1B along the line A-A.

FIG. 1D illustrates a top view of the computer security lock of FIG. 1A in an unlocked position.

FIG. 1E illustrates a section view of the computer security lock of FIG. 1D along the line B-B.

FIG. 1F illustrates a side view of the computer security lock of FIG. 1A in a locked position.

FIG. 1G illustrates a section view of the computer security lock of FIG. 1F along the line A-A.

FIG. 2A illustrates an exploded view of a computer security lock, according to a second embodiment.

FIG. 2B illustrates a side view of the computer security lock of FIG. 2A in an unlocked position.

FIG. 2C illustrates a section view of the computer security lock of FIG. 2B along the line A-A.

FIG. 2D illustrates a top view of the computer security lock of FIG. 2A in an unlocked position.

FIG. 2E illustrates a section view of the computer security lock of FIG. 2D along the line B-B.

FIG. 2F illustrates a side view of the computer security lock of FIG. 2A in a locked position.

FIG. 2G illustrates a section view of the computer security lock of FIG. 2F along the line A-A.

FIG. 3 illustrates an alternative embodiment of a computer security lock.

FIG. 4 illustrates an exploded view of the computer security lock of FIG. 3.

FIG. 5 illustrates an interior view of the computer security lock of FIG. 3.

FIG. 6 illustrates an interior view of the computer security lock of FIG. 3 with a rotatable locking arm in a retracted position.

FIG. 7 illustrates an interior view of the computer security lock of FIG. 3 with a rotatable locking arm in a deployed position.

FIG. 8 illustrates an interior view of the computer security lock of FIG. 3 with a rotatable locking arm in a deployed position.

FIG. 9A illustrates an exploded view of a latching mechanism of the computer security lock of FIG. 3.

FIGS. 9B and C illustrate views of the latching mechanism of FIG. 9A.

### DETAILED DESCRIPTION OF PREFERRED EMBODIMENTS

The components of the embodiments as generally described and illustrated in the figures herein can be arranged and designed in a wide variety of different configurations. Thus, the following more-detailed description of various embodiments, as represented in the figures, is not intended to limit the scope of the present disclosure, but is merely representative of various embodiments. While various aspects of the embodiments are presented in drawings, the drawings are not necessarily drawn to scale unless specifically indicated.

The phrase “coupled to” is broad enough to refer to any suitable coupling or other form of interaction between two or more entities, including mechanical interaction. Thus, two components may be coupled to each other even though they are not in direct contact with each other. The phrases “attached to” or “attached directly to” refer to interaction between two or more entities which are in direct contact with each other or are separated from each other only by a fastener of any suitable variety (e.g., mounting hardware or an adhesive).

Computers and other electronic devices are sometimes targets for theft. To discourage such theft, one solution is to secure the computer or device with a lock mechanism that attaches directly to the computer or device. The computer or device might have a built-in security socket, or security slot, that is configured to accommodate such a lock mechanism. The present disclosure describes computer security locks that improve upon the art. For example, the present disclosure describes a lock in which a spring, elastic member, or biasing member is positioned in a manner superior to that employed by conventional locks. As disclosed herein, springs, elastic members, and the like may be referred to as biasing members.

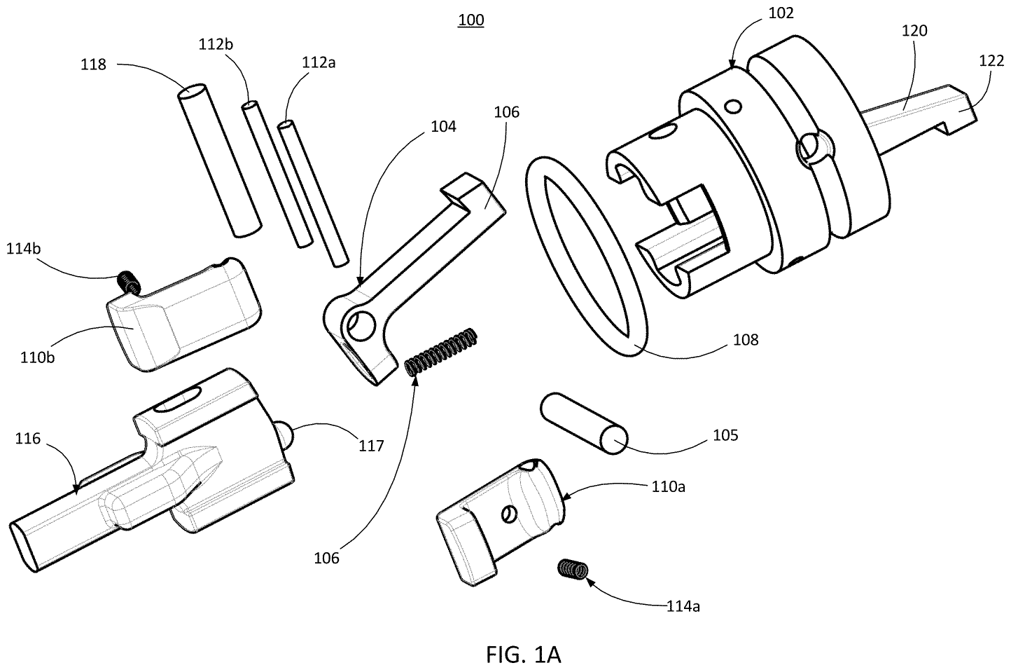

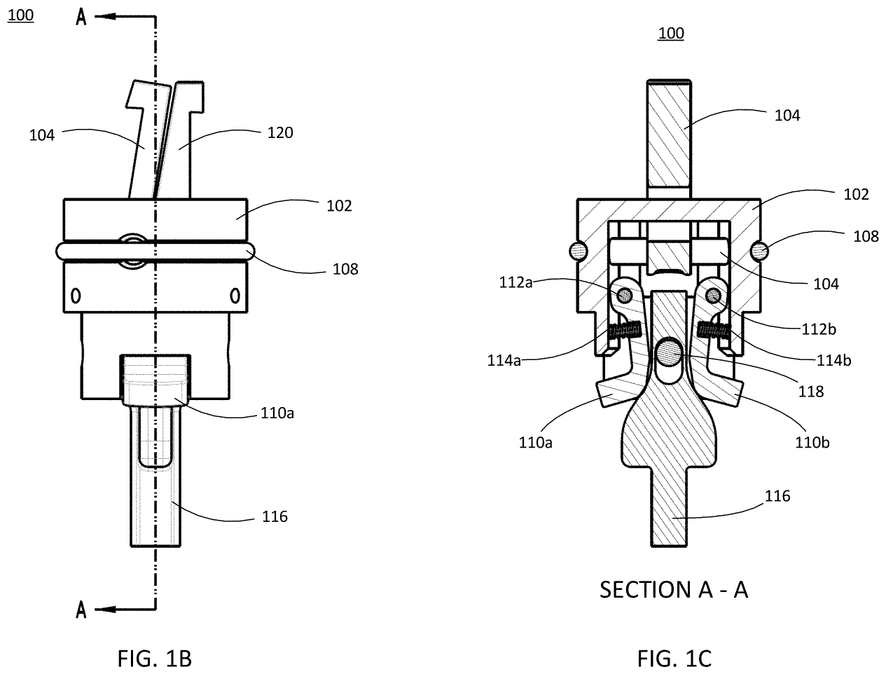

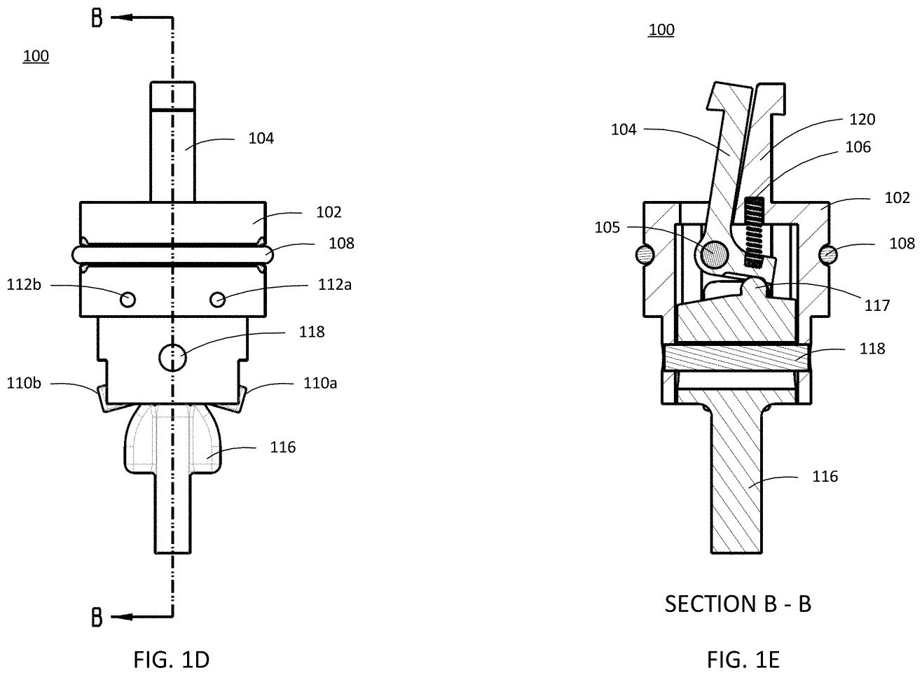

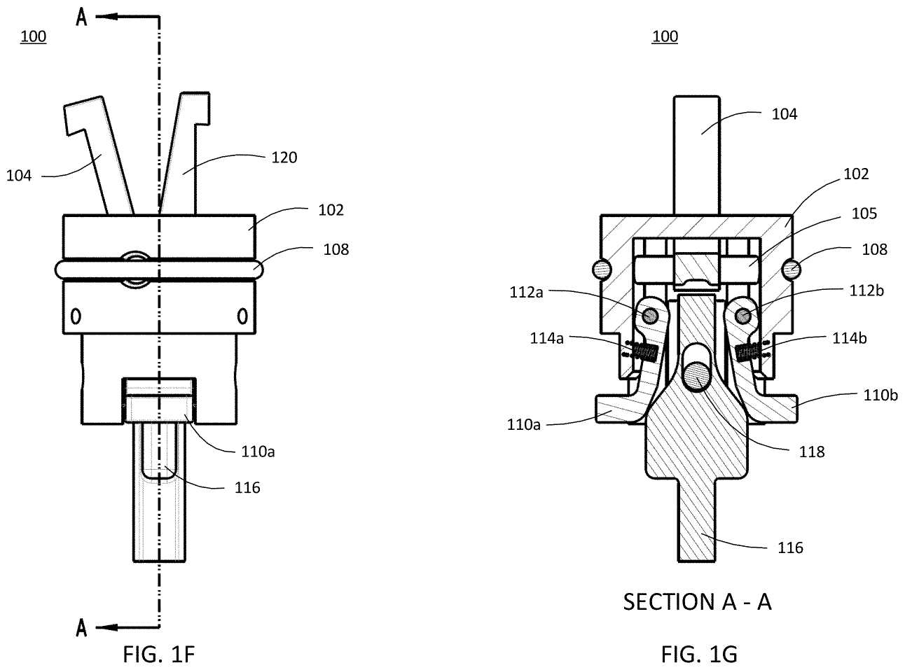

FIGS. 1A-1G depict a computer security lock 100, which is a first embodiment of the present disclosure. FIG. 1A illustrates an exploded view of the computer security lock 100. As shown in FIG. 1A, the computer security lock 100 includes a locking head 102 which may be inserted into a lock housing (not shown). A cable may be attached to the housing to thereby secure the computer security lock 100 to an anchor. The computer security lock 100 includes a rotatable locking arm 102 that is configured to rotate relative to the locking head 102. The rotatable locking arm 102 includes an engagment head 104 that extends at an angle from the main body of the rotatable locking arm 102. The engagement head 104 is configured to engage an interior of a computer slot. The engagement head 104 may extend at a 90 degree angle or at another suitable angle.

The computer security lock 100 includes a locking arm pin 105, a long compression spring or biasing member 106, a retention o-ring 108, a first head locking link 110a, a second head locking link 110b, a first head locking link pin 112a, a second head locking link pin 112b, a first short compression spring 114a, a second short compression spring 114b, a control link 116, and a control link pin 118. Additionally, the locking head 102 includes a fixed locking arm 120 that is attached directly to the locking head 102. The fixed locking arm 120 does not rotate and is rigidly secured to the locking head 102. The fixed locking arm 120 includes an engagment head 122 that extends at an angle from the main body of the fixed locking arm 120. The engagement head 122 is configured to engage an interior of a computer slot and may extend at a 90 degree angle or at another suitable angle.

FIG. 1B illustrates a side view of the computer security lock 100 in an unlocked or retracted position. FIG. 10 illustrates a section view of the computer security lock 100 along the section line A-A of FIG. 1B. As shown in FIGS. 1B-1C, one embodiment of the disclosure is a computer security lock 100 that is assembled with the rotatable locking arm 104 rotatably secured to the locking head 102 by means of the locking arm pin 105. The locking arm pin 104 provides an axis of rotation about which the rotatable locking arm 104 can rotate. In one direction, rotation of the rotatable locking arm 104 is stop-limited by the fixed locking arm 120. In the other direction, rotation of the rotatable locking arm 104 is stop-limited by the structure of the locking head 102. The retention o-ring 108 secures the locking arm pin 105 in place in the locking head 102.

The control link 116 is translatably secured to the locking head 102 by means of the control link pin 118, the first head locking link 110a, and the second head locking link 110b. Translation of the control link 116 may be enacted through use of a conventional combination or keyed mechanism (not shown) which applies a force to the control link 116. The control link 116 may include a protrusion 117 to press against the rotatable locking arm 104, compress the compression spring 106, and thereby move the rotatable locking arm 104.

The first head locking link 110a is rotatably secured to the locking head 102 by means of the first head locking link pin 112a. The second head locking link 110b is rotatably secured to the locking head 102 by means of the second head locking link pin 112b. The first head locking link 110a is additionally coupled to the locking head 102 by the first short compression spring 114a. The second head locking link 114b is additionally coupled to the locking head 102 by the second short compression spring 114b.

FIG. 1D illustrates a top view of the computer security lock 100 in an unlocked position. FIG. 1E illustrates a section view of the computer security lock 100 along the section line B-B of FIG. 1D. A longitudinal axis of the computer security lock 100 is defined by the intersection of section plane A-A, shown in FIG. 1B and section plane B-B, shown in FIG. 1D. In other words, the longitudinal axis of the computer security lock 100 coincides with the centerline of the locking head 102. Movement along the longitudinal axis is said to be longitudinal movement or movement in a longitudinal direction.

As shown in FIGS. 1D-1E, the computer security lock 100 employs the long compression spring 106 configured to provide a resistive force against the rotatable locking arm 104. The resistive force provided by the long compression spring 106 is directed parallel to the longitudinal axis of the computer security lock 100.

FIG. 1F illustrates a side view of the computer security lock 100 in a locked configuration. FIG. 1G illustrates a section view of the computer security lock 100 along the section line A-A of FIG. 1F. The section line A-A of FIG. 1F is the same line as the section line A-A of FIG. 1B. As shown in FIGS. 1F-1G, the computer security lock 100 assumes a locked or deployed configuration when the control link 116 is pushed in a longitudinal direction toward the rotatable locking arm 104. This pushing action moves the rotatable locking arm 104 and concurrently causes the rotatable locking arm 104 to push against the long compression spring 106. The long compression spring 106 concurrently compresses into a compressed state and provides a force against the rotatable locking arm 104. Additionally, concurrently with the pushing of the control link 116 toward the rotatable locking arm 104, the head locking links 110a and 110b are rotationally displaced about their respective axes defined by the head locking link pins 112a and 112b. When the computer security lock 100 is in the locked or deployed configuration, the head locking links 110a and 110b respectively compress the short compression springs 114a and 114b, which respectively provide resistive forces opposing the rotation of the head locking links 110a and 110b.

The head locking links 110a and 110b may be employed by additional components to retain the computer security lock 100 in its locked configuration. The additional components that are needed to complete a computer security lock assembly beyond the computer security lock 100 of the present disclosure are known in the art.

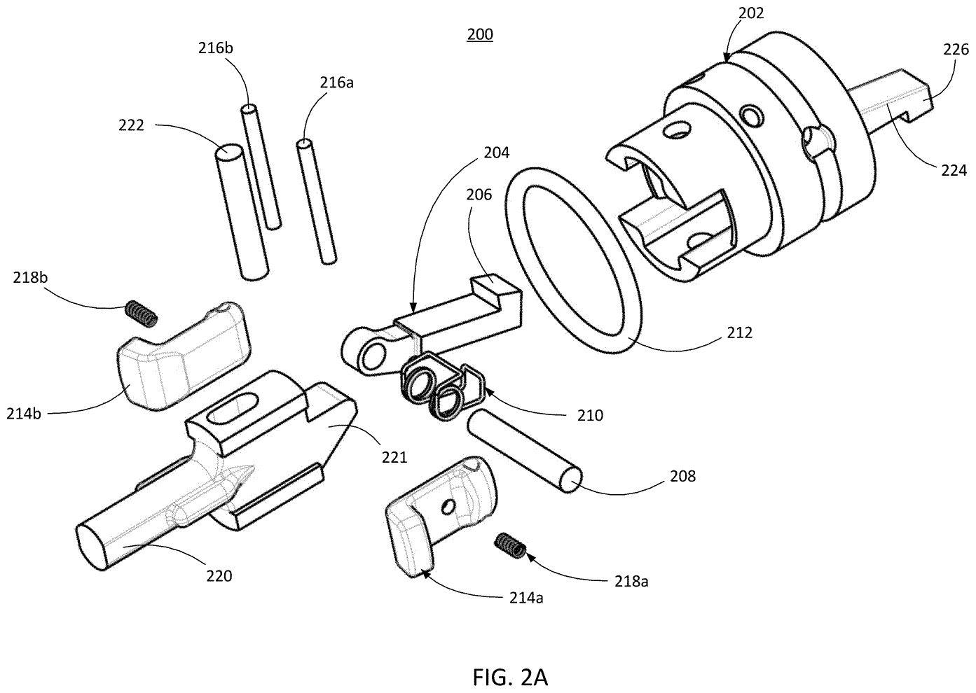

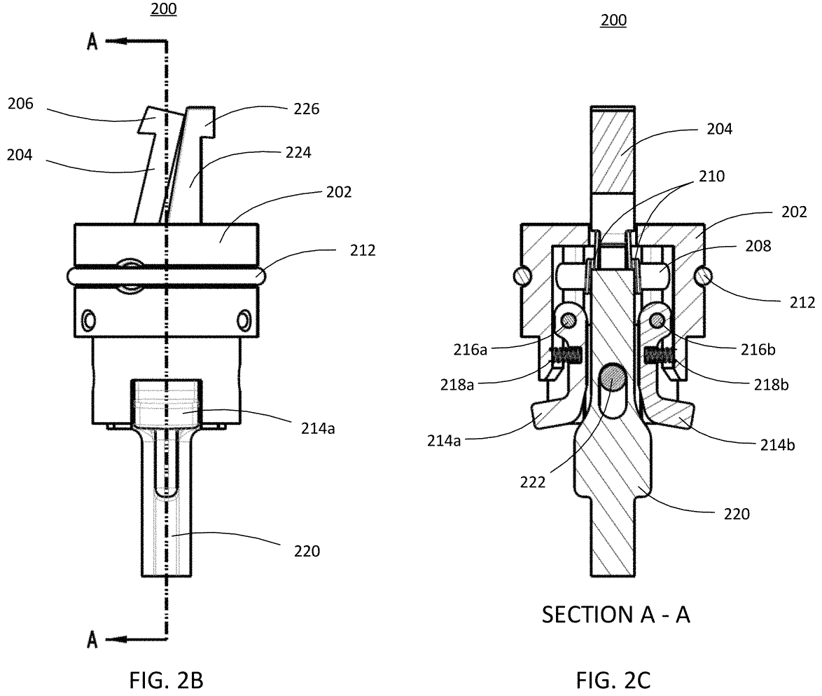

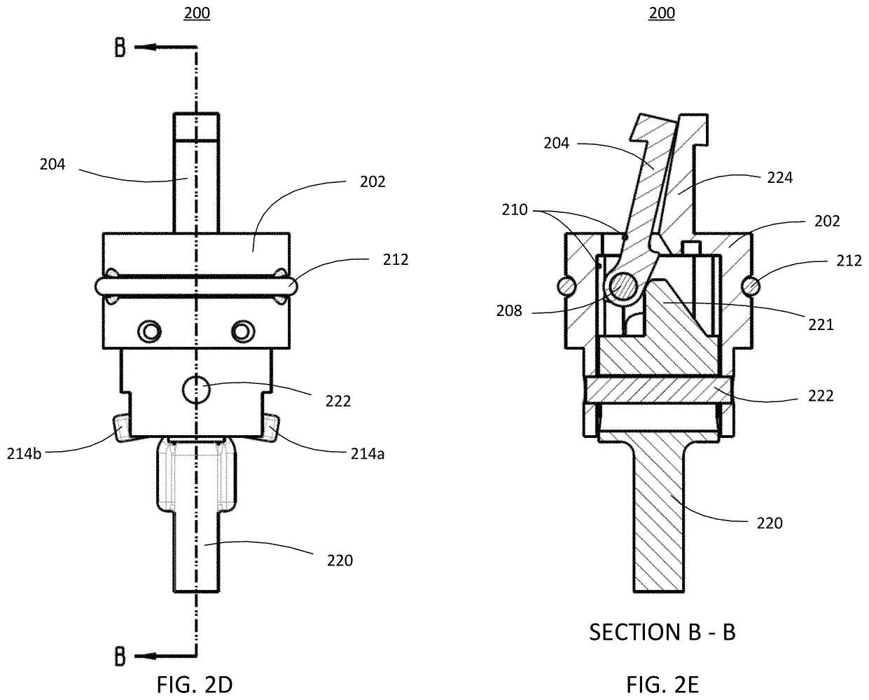

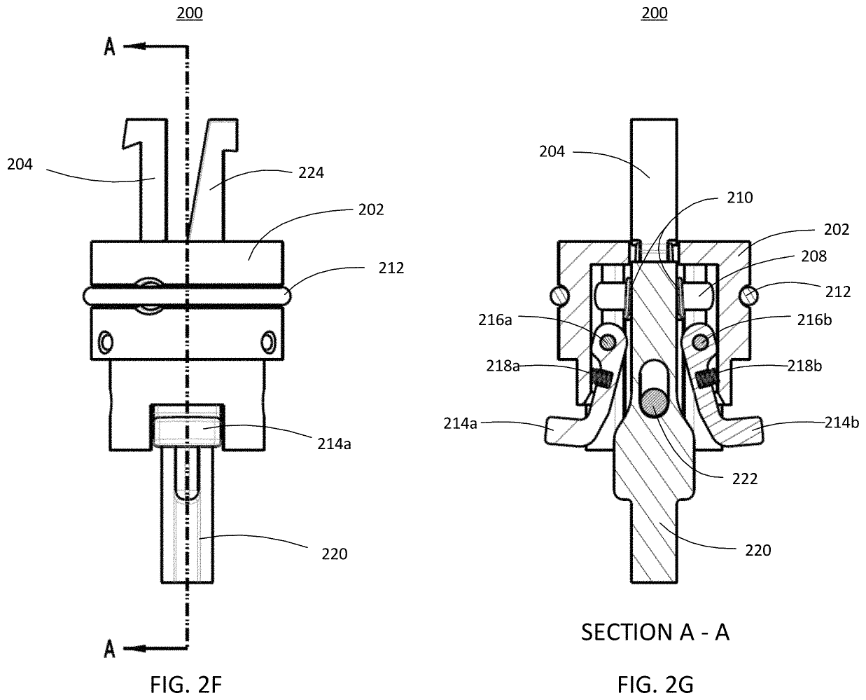

FIGS. 2A-2G depict a computer security lock 200, which is a second embodiment of the present disclosure. FIG. 2A illustrates an exploded view of the computer security lock 200. As shown in FIG. 2A, the computer security lock 200 includes a locking head 202, a rotatable locking arm 204 including an engagement head 206, a locking arm pin 208, a torsion spring 210, a retention o-ring 212, a first head locking link 214a, a second head locking link 214b, a first head locking link pin 216a, a second head locking link pin 216b, a first short compression spring 218a, a second short compression spring 218b, a wedge control link 220, and a wedge control link pin 222. Additionally, the locking head 202 includes a fixed locking arm 224 that is rigidly attached to the locking head 202. The fixed locking arm 224 does not move relative to the locking head 202 and includes an engagement head 226.

FIG. 2B illustrates a side view of the computer security lock 200 in an unlocked position. FIG. 2C illustrates a section view of the computer security lock 200 along the section line A-A of FIG. 2B. As shown in FIGS. 2B-2C, an embodiment of the disclosure is a computer security lock 200 that is assembled with the rotatable locking arm 204 rotatably secured to the locking head 202 by means of the locking arm pin 208. The locking arm pin 208 provides an axis of rotation about which the rotatable locking arm 204 can rotate. In one direction, rotation of the rotatable locking arm 204 is stop-limited by the fixed locking arm 224. In the other direction, rotation of the rotatable locking arm 204 is resisted by the torsion spring 210 and stop-limited by the structure of the locking head 202. The retention o-ring 212 secures the locking arm pin 208 in place in the locking head 202.

The wedge control link 220 is translatably secured to the locking head 202 by means of the wedge control link pin 222, the first head locking link 214a, and the second head locking link 214b. The first head locking link 214a is rotatably secured to the locking head 202 by means of the first head locking link pin 216a. The second head locking link 214b is rotatably secured to the locking head 202 by means of the second head locking link pin 216b. The first head locking link 214a is additionally coupled to the locking head 202 by the first short compression spring 218a. The second head locking link 214b is additionally coupled to the locking head 202 by the second short compression spring 218b. The wedge control link 220 may include a wedge-shaped protrusion 221 to press against the rotatable locking arm 204 and thereby move the rotatable locking arm 204.

FIG. 2D illustrates a top view of the computer security lock 200 in an unlocked position. FIG. 2E illustrates a section view of the computer security lock 200 along the section line B-B of FIG. 2D. A longitudinal axis of the computer security lock 200 is defined by the intersection of section plane A-A, shown in FIG. 2B and section plane B-B, shown in FIG. 2D. In other words, the longitudinal axis of the computer security lock 200 coincides with the centerline of the locking head 202. Movement along the longitudinal axis is said to be longitudinal movement or movement in a longitudinal direction.

As shown in FIGS. 2D-2E, the computer security lock 200 employs the torsion spring 210 configured to provide a resistive torque against the rotatable locking arm 204. The resistive torque provided by the torsion spring 210 is directed opposite the rotational direction in which the rotatable locking arm 204 moves when pushed into a locked configuration.

FIG. 2F illustrates a side view of the computer security lock 200 in a locked configuration. FIG. 2G illustrates a section view of the computer security lock 200 along the section line A-A of FIG. 2F. The section line A-A of FIG. 2F is the same line as the section line A-A of FIG. 2B. As shown in FIGS. 2F-2G, the computer security lock 200 assumes a locked configuration when the wedge control link 220 is pushed in a longitudinal direction toward the rotatable locking arm 204. This pushing action moves the rotatable locking arm 204 and concurrently causes the rotatable locking arm 204 to compress the torsion spring 210. The torsion spring 210 concurrently compresses into a compressed state and provides a torque against the rotatable locking arm 204. Additionally, concurrently with the pushing of the wedge control link 220 toward the rotatable locking arm 204, the head locking links 214a and 214b are rotationally displaced about their respective axes defined by the head locking link pins 216a and 216b. When the computer security lock 200 is in the locked configuration, the head locking links 214a and 214b respectively compress the short compression springs 218a and 218b, which respectively provide resistive forces opposing the rotation of the head locking links 214a and 214b.

The head locking links 214a and 214b may be employed by additional components to retain the computer security lock 200 in its locked configuration. The additional components that are needed to complete a computer security lock assembly beyond the computer security lock 200 of the present disclosure are known in the art.

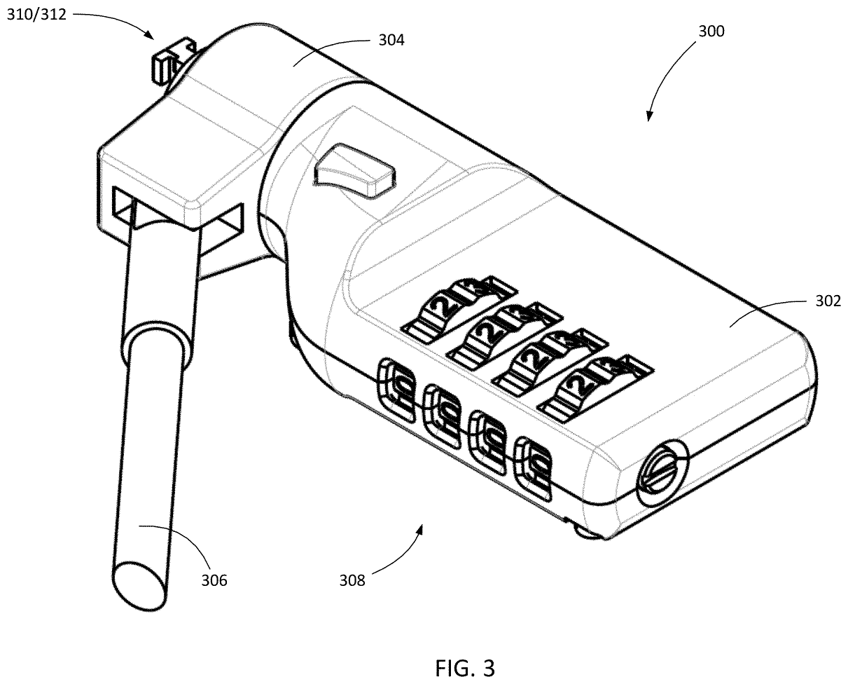

FIG. 3 illustrates an embodiment of a security lock 300 including a housing 302, cable yoke 304, cable 306, and a combination mechanism 308. The cable 306 is used to secure the lock 300 to a suitable anchor as is commonly known in the art. The combination mechanism 308 may be any one of various conventional combination mechanisms and may also be interchanged with a key mechanism. The security lock 300 further includes locking arms 310, 312 extending from the cable yoke 304 and housing 302. A fixed locking arm 310 is rigid and does not pivot, rotate or otherwise move. In one embodiment, the fixed locking arm 310 is secured to the housing 302. A rotatable locking arm 312 pivots from deployed to retracted positions to allow the lock 300 to engage and disengage with a computer slot.

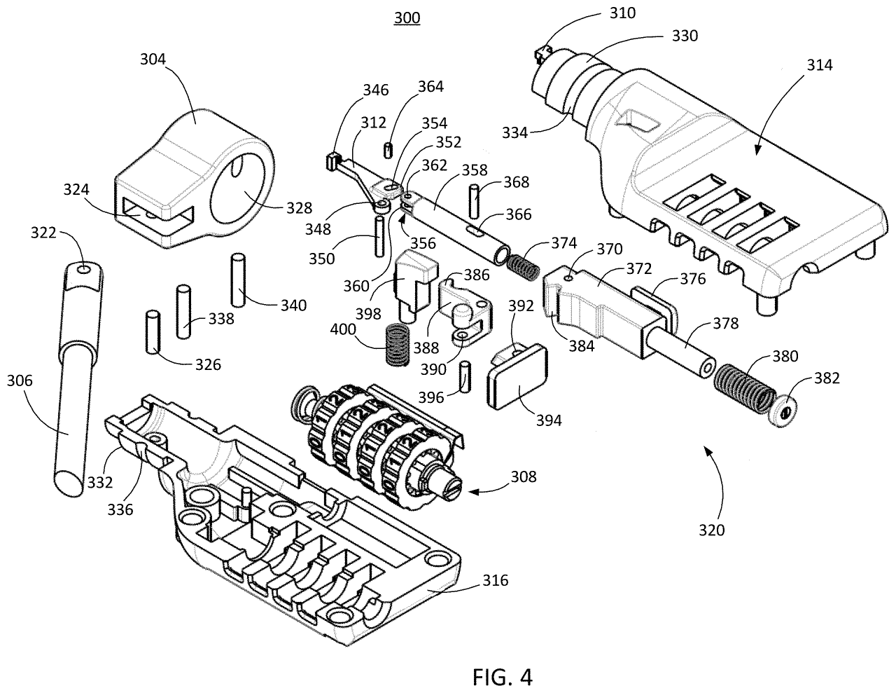

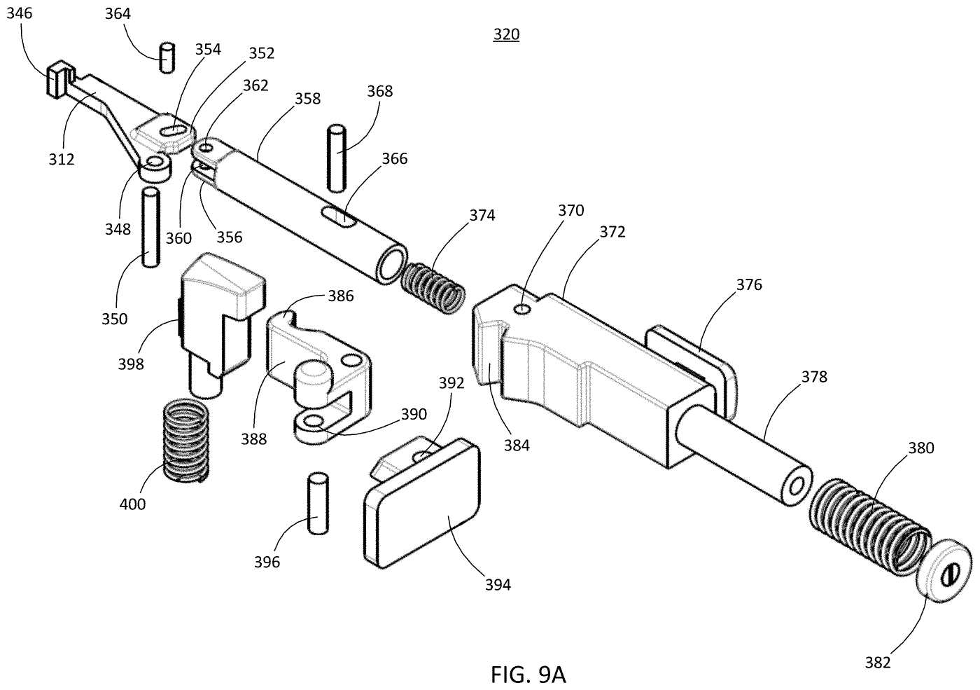

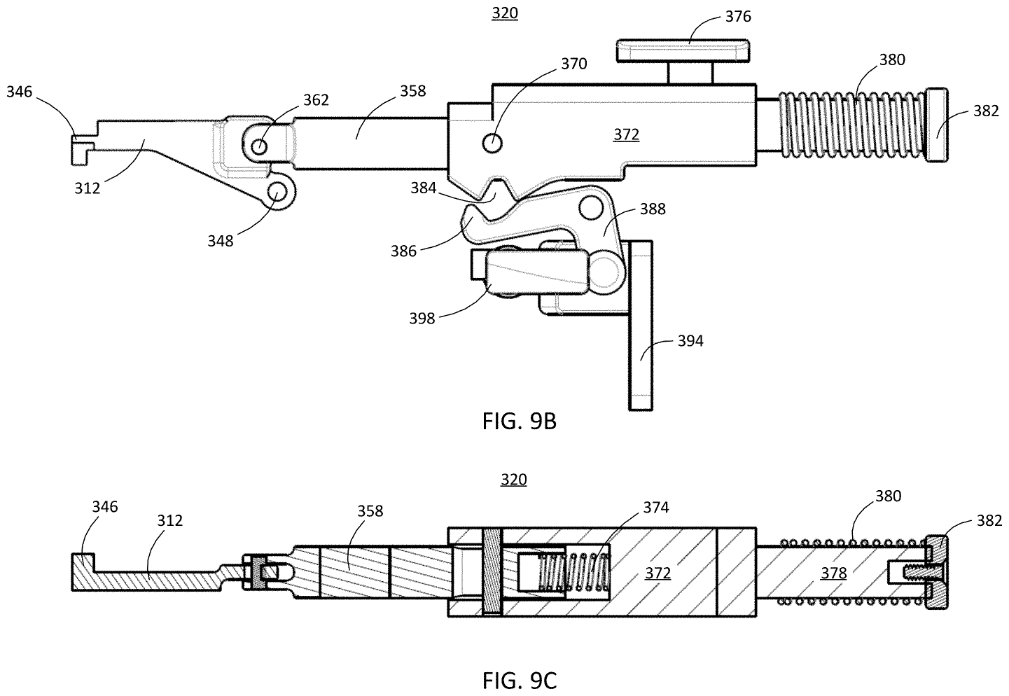

FIG. 4 illustrates an exploded view of the security lock 300 of FIG. 3. The lock 300 includes an upper housing 314 and a lower housing 316 which are coupled together to contain various elements described herein including a combination mechanism 308 and a latching mechanism 320. The fixed locking arm 310 is attached to the upper housing 314. The latching mechanism 320 includes the rotatable locking arm 312 and the latching mechanism 320 is described in further detail in reference to FIGS. 9A-C.

The cable 306 includes a cable aperture 322 which is received in a cable yoke slot 324. A cable pin 326 extends through the cable aperture 322 and the cable yoke slot 324 to rotatably secure the cable 206 to the cable yoke 304.

The upper and lower housings 314, 316 each include a corresponding collar 328, 330 through which the rotatable locking arm 312 at least partially extends. The cable yoke 304 includes a collar aperture 328 into which the collar 330, 332 is inserted. The collar 330, 332 includes pin grooves 334, 336 that at least partially receive lock pins 338, 340 once the collar 330, 332 is inserted in the collar aperture 328. The lock pins 338, 340 are coupled to the cable yoke 304 and, when inserted into the pin grooves 334, 336, retain the collar 330, 332 in the collar aperture 328.

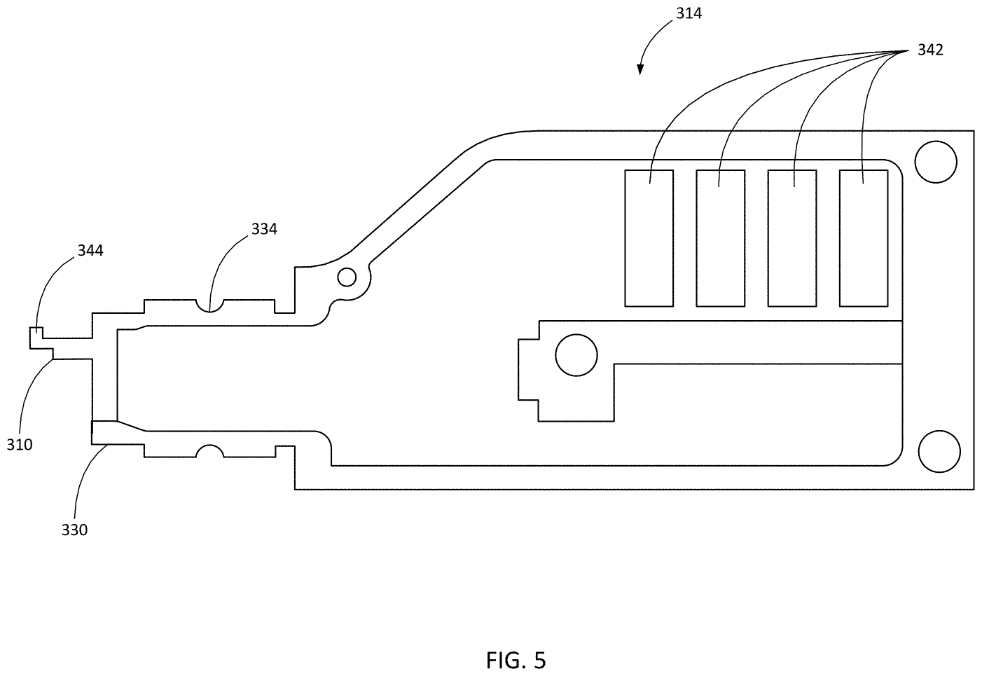

FIG. 5 illustrates an interior of the upper housing 314. The upper housing 314 includes lock windows 342 which receive corresponding number dials of the combination mechanism 308. The fixed locking arm 310 is secured to the upper housing 314 such that the fixed locking arm 310 is incapable of moving. The fixed locking arm 310 includes an engagement head 344 that protrudes from the fixed locking arm 310 to engage and secure the lock 300 to a slot. As illustrated, the engagement head 344 extends approximately perpendicular to the fixed locking arm 310. As can be appreciated, the engagement head 344 may extend at various angles to accommodate securement of the lock 300 to a computer slot.

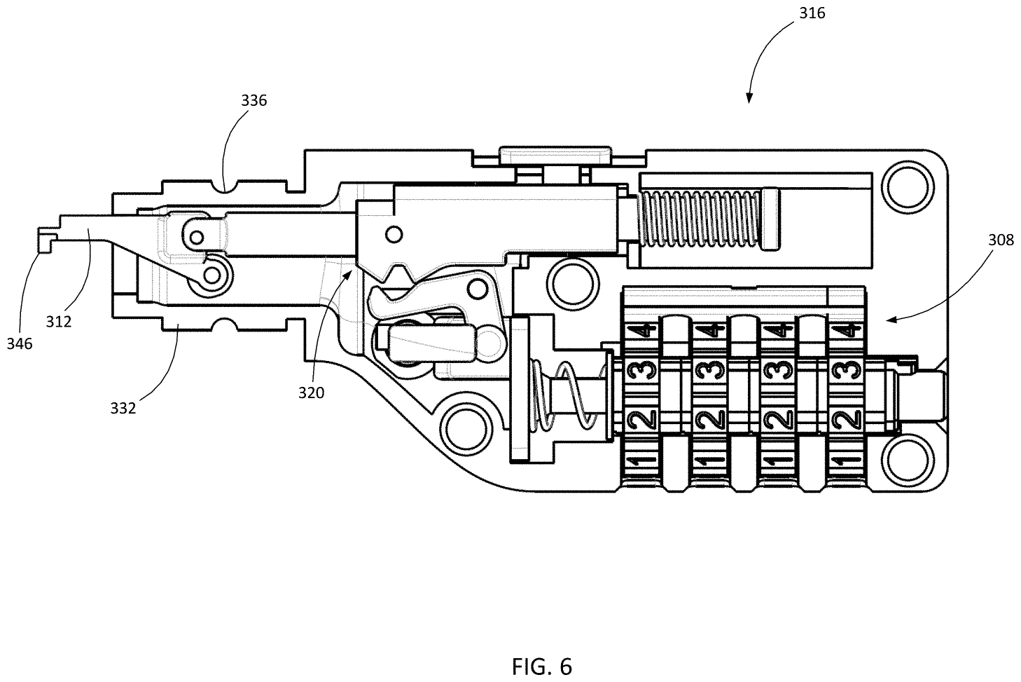

FIG. 6 illustrates an interior of the lower housing 316 with the latching mechanism 320 and the combination mechanism 308 at least partially contained therein. The combination mechanism 308 and latching mechanism 320 operate in conjunction to effect movement of the rotatable locking arm 312 from deployed to retracted positions. The rotatable lock arm 312 includes a corresponding engagment head 346 to engage an interior of a computer slot. As illustrated the engagement head 346 may extend approximately perpendicular to the rotatable lock arm 312. Alternatively, the engagement head 346 may extend at various angles to accommodate securement of the lock 300 with a computer slot. Description of the latching mechanism 320 is provided in reference to FIGS. 9A-C below. The rotatable locking arm 312 is shown in a retracted position so that the engagement head 346 may be removed from a computer slot. As such, the rotatable locking arm extends approximately parallel to an axis of the collar 332.

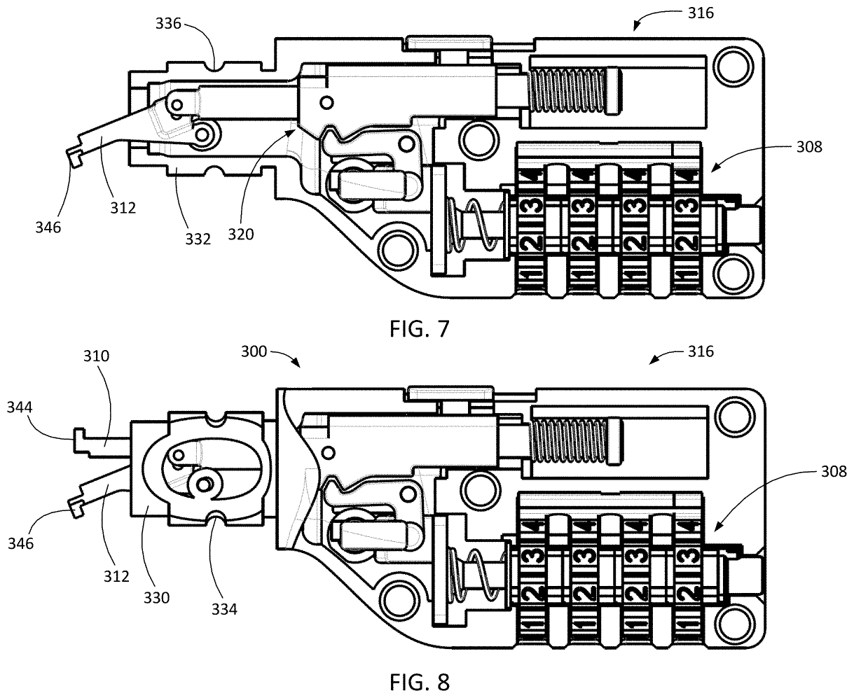

FIG. 7 illustrates the elements of FIG. 6 with the rotatable lock arm 312 in a deployed position. In a deployed position, the rotatable lock arm 312 extends at an angle to the axis of the collar 332.

FIG. 8 illustrates the lock 300 with part of the upper housing 314 cut away. The fixed locking arm 310 and the rotatable locking arm 312 are shown relative to one another with the rotatable locking arm 312 in the deployed position. In the deployed position, the rotatable locking arm 312 extends away from the fixed locking arm 310. In the retracted position, the fixed locking arm 310 and the rotatable locking arm 312 are proximate to one another to allow disengagement from a computer slot.

FIGS. 9A-C illustrate an embodiment of a latching mechanism 320 which interfaces with the combination mechanism 308 to effect movement of the rotatable locking arm 312. The latching mechanism 320 includes the aforementioned rotatable locking arm 312 that includes a rotation axel aperture 348 to receive a rotation axel 350. The rotatable locking arm 312 rotates around the rotation axel 350 from the deployed to the retracted positions and visa versa. The rotatable locking arm 312 includes a connection end 352 and a connection aperture 354 that couple to a connecting end 356 of an activating linkage 358 or link 358. The connecting end 356 includes a connection groove 360 to receive the connecting end 356 and a groove aperture 362. The groove aperture 362 and the connection aperture 354 align with one another and receive a connection pin 364 to secure the rotatable locking arm 312 to the activating linkage 358.

The activating linkage 358 translates along a longitudinal axis of the lock 300 to apply a force to the rotatable locking arm 312 to move the rotatable locking arm into the deployed or lock position.

The activating linkage 358 includes a connection aperture 366 to receive a connection pin 368. The connection aperture 366 aligns with a connection aperture 370 of a slide switch 372. The connection pin 368 is inserted into the connection apertures 366, 370 to thereby couple the activating linkage 358 to the slide switch 372. A compressing spring 374 is disposed between the activating linkage 358 and the slide switch 372 to allow compliance between the activating linkage 358 and the slide switch 372. The slide switch 372 includes a slide switch plate 376 that extends from the upper housing 314 to allow user operation of the slide switch 372. The slide switch plate 376 is configured to enable a user's thumb to translate the slide switch 372 and the activating linkage 358 along a longitudinal axis of the lock 300 to thereby position the rotatable locking arm 312 into the deployed position.

The slide switch 372 includes a slide arm 378 that receives a return spring 380. An end cap 382 secures the placement of the return spring to the slide arm 378.

The slide switch 372 includes a lock groove 384 to receive an engagement head 386 of a locking pawl latch 388. The locking pawl latch 388 rotates to enable engagement and disengagement of the engagement head 386 with the lock groove 384.

The locking pawl latch 388 includes a connection aperture 390 that aligns with a connection aperture 392 of a locking release plate 394. A connection pin 396 is inserted into the connection apertures 390, 392 to secure the locking pawl latch 388 to the locking release plate 394. The combination mechanism 208 applies pressure to the locking release plate 394 to disengage the locking prawl latch 388 from the lock groove 384 of the slide switch 372.

A release button 398 is partially extends through the upper housing 314 and is in contact with a release spring 400. The release button 398 enables user operation to disengage the locking prawl latch 388 from the lock groove 384.

This disclosure has been made with reference to various exemplary embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced, are not to be construed as a critical, required, or essential feature or element. The scope of the present invention should, therefore, be determined by the following claims.

1. A lock to engage with a slot in portable electronic device, comprising:
a housing;
a fixed locking arm rigidly disposed relative to the housing and including an engagement head configured to engage with the slot;
a rotatable locking arm rotatably disposed relative to the housing and including an engagement head configured to engage with the slot; the rotatable locking arm rotating from a retracted position, wherein the rotatable locking arm is in proximity to the fixed locking arm, to a deployed position, wherein the rotatable locking arm extends from the rotatable locking arm;
a link in contact with the rotatable locking arm and configured to translate along a longitudinal axis of the lock to thereby move the rotatable locking arm; and
a biasing member to provide a resistive force against the rotatable locking arm when the rotatable locking arm is in the deployed position.

2. The lock of claim 1, wherein the link is secured to the rotatable locking arm.

3. The lock of claim 1, wherein the link includes a wedge shape.

4. The lock of claim 1, wherein the housing includes a collar and wherein the fixed locking arm and the rotatable locking arm at least partially extend through the collar.

5. The lock of claim 4, further comprising:
a cable yoke disposed at least partially around the collar; and
a cable rotatably connected to the cable yoke.

6. The lock of claim 1, wherein the biasing member includes a compression spring aligned parallel with the longitudinal axis of the lock.

7. The lock of claim 1, further comprising:
a head locking link rotatably disposed in the housing and in contact with the link as the link translates along the longitudinal axis of the lock; and
a compression spring in contact with the head locking link to provide a resistive force against the rotation of the head locking link.

8. The lock of claim 1, further comprising a slide switch, at least partially disposed within the housing, and coupled to the link, wherein the biasing member is coupled to the slide switch.

9. A lock to engage with a slot in portable electronic device, comprising:
a housing;
a fixed locking arm rigidly coupled to the housing and including an engagement head configured to engage with the slot;
a rotatable locking arm rotatably disposed relative to the housing and including an engagement head configured to engage with the slot, the rotatable locking arm including a rotation axel secured within the housing and about which the rotatable locking arm rotates,
wherein the rotatable locking arm rotating from a retracted position, wherein the rotatable locking arm is in proximity to the fixed locking arm, to a deployed position, wherein the rotatable locking arm extends from the rotatable locking arm;
a link coupled with the rotatable locking arm and configured to translate along a longitudinal axis of the lock to thereby move the rotatable locking arm; and
a biasing member to provide a resistive force against the rotatable locking arm when the rotatable locking arm is in the deployed position.

10. The lock of claim 9, furthering comprising a slide switch, at least partially disposed within the housing, and coupled to the link and wherein wherein the biasing member is coupled to the slide switch.

11. The lock of claim 10, wherein the slide switch includes a slide switch plate extending from the housing and configured to enable a user to translate the slide switch and the link along the longitudinal axis of the lock and apply force against the biasing member to move the rotatable locking arm into a deployed position.

12. The lock of claim 10, wherein the slide switch includes a slide arm engaged with the biasing member.

13. The lock of claim 10, further comprising a locking prawl latch disposed within the housing and wherein the slide switch includes a lock groove configured to receive a portion of the locking prawl latch and thereby retain the rotatable locking arm in the deployed position.

14. The lock of claim 13, further comprising a locking release plate in contact with the locking prawl latch, the locking release plate configured to translate along the longitudinal axis of the lock to apply a release force to disengage the locking prawl latch from the lock groove.

15. The lock of claim 14, further comprising a combination mechanism in contact with the locking release plate, the combination mechanism configured to apply a release force to the locking release plate.

16. The lock of claim 14, further comprising a release button at least partially extending through the housing to enable user operation and configured to contact the locking prawl latch to disengage the locking prawl latch from the lock groove.

17. The lock of claim 9, wherein the housing includes a collar and wherein the fixed locking arm and the rotatable locking arm at least partially extend through the collar.

18. The lock of claim 16, further comprising:
a cable yoke disposed at least partially around the collar; and
a cable rotatably connected to the cable yoke.

19. The lock of claim 9, wherein the biasing member includes a compression spring aligned parallel with the longitudinal axis of the lock.

20. A lock to engage with a slot in portable electronic device, comprising:
a lock head including:
a fixed locking arm rigidly coupled to the lock head and including an engagement head configured to engage with the slot;
a rotatable locking arm rotatably coupled to the lock head and including an engagement head configured to engage with the slot; the rotatable locking arm rotating from a retracted position, wherein the rotatable locking arm is in proximity to the fixed locking arm, to a deployed position, wherein the rotatable locking arm extends from the rotatable locking arm;
a link in contact with the rotatable locking arm and configured to translate along a longitudinal axis of the lock head to thereby move the rotatable locking arm; and
a biasing member to provide a resistive force against the rotatable locking arm when the rotatable locking arm is in the deployed position.
